(19) United States
(12) Patent Application Publication
(10) Pub. No.: US 2019/0104747 A1
(43) Pub. Date: Apr. 11, 2019

(54) Time Saver

(71) Applicant: Cassandra Linette Robertson, Jacksonville, FL (US)

(72) Inventor: Cassandra Linette Robertson, St. Augustine, FL (US)

(21) Appl. No.: 15/863,908

(22) Filed: Feb. 20, 2018

Related U.S. Application Data
(60) Provisional application No. 62/460,082, filed on Feb. 16, 2017.

(51) Int. Cl. A22C 17/08

(52) U.S. Cl. CPC A22C 17/08

(57) ABSTRACT

The Time Saver is a kitchen apparatus comprised of various compartments working in conjunction to thoroughly clean raw meat before cooking.

The top compartment is temperature-controlled via heating elements installed on both sides. The central compartment will be similar in appearance and function to a rotisserie oven with a glass door. The central compartment has holes at the bottom for draining into the third compartment and will also contain a basket that holds the raw meat and small brush for extra cleaning. The third and final compartment receives the contaminated water from the meat washing process. The dirty water will be drained via a hose attached to the device. All parts of the device are intended to be washable and or dishwasher safe, allowing for multiple uses. Exact size, measurement, construction, and design specifications may vary upon manufacturing.

### BACKGROUND OR PROBLEM

Cross contamination can occur when cleaning and preparing large amounts of raw meat in the kitchen. Food poisoning, salmonella, E-coli, and other illnesses can be product of the poor or improper preparation of foods. Many chefs do not have the necessary knowledge to effectively and safely clean meats when preparing them for consumption. A suitable solution is desired.

### SOLUTION

Man people practice food safety to avoid food-borne illness. Food safety is a scientific discipline describing handling, preparation, and storage of food in ways that prevent food-borne illness. This includes a number of routines that should be followed to avoid potentially severe health hazards. Food can transmit disease from person to person as well as serve as a growth medium for bacterial that can cause food poisoning.

The present invention provides users with a compartmented machine designed to wash raw meat, removing the risk of any cross-contamination during preparation. It includes a top compartment with a heating element, allowing meat to be cleaned in a temperature-controlled environment for maximum efficiency. It features a rotisserie-like mechanism, with a set of holes, in the middle of the device designed to hold the raw meat and allow contaminated water to drip down into the bottom portion. This allows dirty or contaminated water to be drained from the bottom of the device via a hose, elimination the need for any hand contact with the meat or water as the meat is being cleaned. The present invention offers a much more convenient and time-saving method to cleaning raw meat before it is cooked on a stove, baked in an oven, grilled and more.

### DETAILED DESCRIPTION OF INVENTION

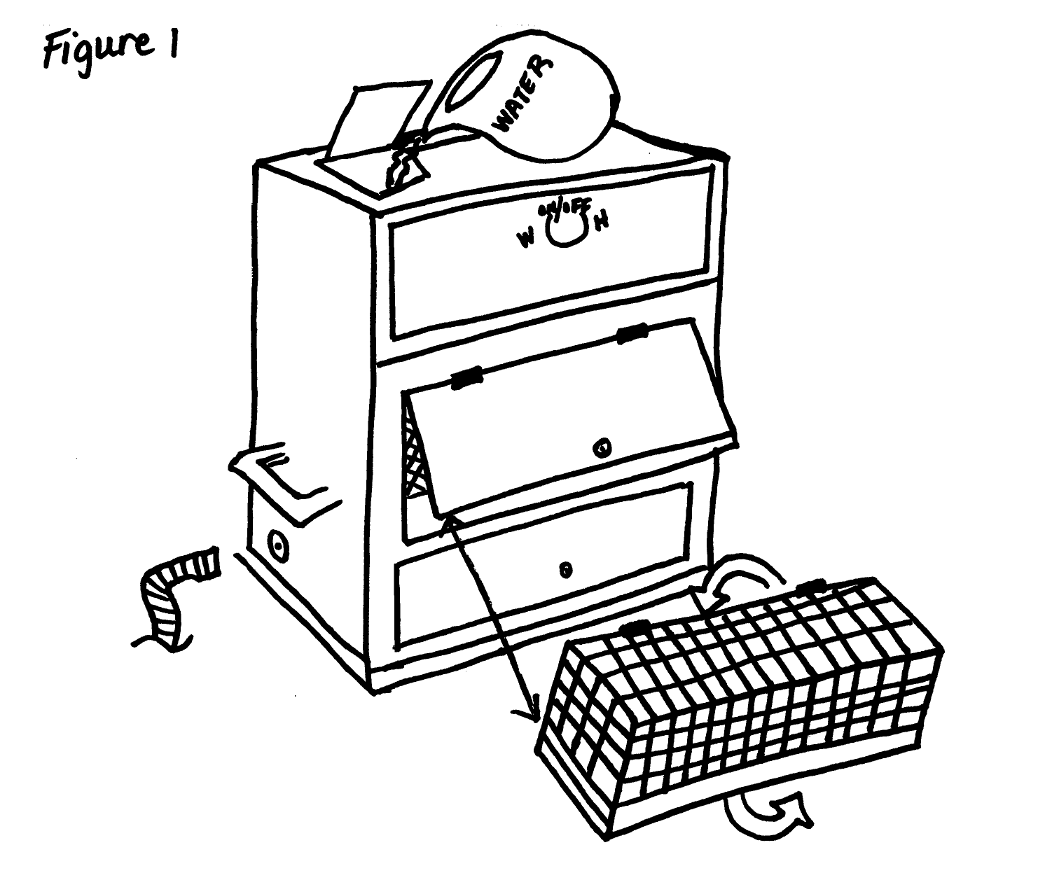

Referring now to FIG. 1, The Time Saver is a kitchen apparatus for washing various quantities of raw meat. The machine is comprised of various compartments working in conjunction to clean and prepare raw meats for stovetop cooking, baking, grilling, and more. A meat cleaning brush may also be included with the device, enabling users to further clean raw meat if necessary.

The top compartment of the device is temperature-controlled via heating elements installed on both sides. The central compartment will be similar in appearance and function to a rotisserie oven device, equipped with a glass door for viewing meat during the cleaning process. The central compartment will also contain a basket, allowing the meat cleaning brush to be utilized with ease.

Beneath the central compartment is a third and final compartment capable of receiving contaminated water from the meat washing process. The middle compartment features holes which allow water drip down into the bottom compartment. The dirty water will be stored in the bottom and then released via a hose when required.

The Time Saver can be constructed using metal, plastic, and other suitable materials. All parts of the device are intended to be washable, allowing for multiple uses. The device may be exceptionally helpful for commercial kitchens and those preparing meats for large numbers of people. Exact size, measurement, construction, and design specifications may vary upon manufacturing.

### DETAILED DESCRIPTION OF DRAWINGS ATTACHED

FIG. 1 shows an illustration of the device and its components, highlighting heating element installed on the top compartment and it shows an illustration of the device and its components and how/where other heating elements can be installed.

The foregoing descriptions of specific embodiments of the present invention have been presented for purposes of illustrations and descriptions. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. The Time Saver was developed as a kitchen device that can stop the cross contamination that often occurs when handling raw meats, it is designed to effectively clean and prepare raw meat for cooking, this device consist of various compartments that will work together, the top compartment is temperature controlled allowing meat to be cleaned with hot, warm, or cold water, burners are located on the sides of the top compartment, the water will drip from spouts located at the bottom of the upper compartment onto the raw meat in the central compartment below, as the meat rotates in a basket the water will clean the raw meat removing germs and bacteria prior to cooking, the central compartment similar in appearance and function to a rotisserie device is equipped with a glass door for viewing the meat cleaning process, this area contains a basket to hold small portions of raw meat for more effective cleaning, the central compartment will allow the cook to add, remove, and adjust placement of meat during cleaning to ensure the meat is rotating properly, a meat cleaning brush is included enabling a user to gently brush the meat to remove any left-over residue that may have been caught by the basket, beneath the central compartment is a strainer that drains the water into the third compartment, the third compartment features a recessed tray designed to allow for easy removal and disposal of contaminated water, there is a hole on the side of this compartment which contains a hose that will help drain the third compartment directly into the sink without the user ever touching the dirty water, all parts are durable and washable for reuse, this device contains the circuitry and components necessary for each described function, while this device is expected to use standard electrical currents, design modifications may be made as determined by the manufacturing agent, sizes, shapes and materials may vary and this product may be offered in both home consumer and/or commercial/industrial designs.
